(19) United States
(12) Patent Application Publication
(10) Pub. No.: US 2010/0068669 A1
(43) Pub. Date: Mar. 18, 2010

(54) CONTINUOUS HEAT TREATMENT FURNACE

(75) Inventors: Takashi ISHIMOTO, Nagoya-shi (JP); Takaya Ochiai, Nagoya-shi (JP); Kenji Shimizu, Nagoya-shi (JP); Masato Ogawa, Nagoya-shi (JP)

Correspondence Address: BACON & THOMAS, PLLC, 625 SLATERS LANE, FOURTH FLOOR, ALEXANDRIA, VA, 22314-1176, US

(73) Assignee: DAIDO TOKUSHUKO KABUSHIKI KAISHA, Tokyo (JP)

(21) Appl. No.: 12/560,085

(22) Filed: Sep. 15, 2009

(30) Foreign Application Priority Data
Sep. 18, 2008 (JP) 2008-239515

(51) Int. Cl. F27D 15/02

(52) U.S. Cl. 432/77

(57) ABSTRACT

The present invention provides a continuous heat treatment furnace including: a heating chamber heating a treatment object in an inert gas atmosphere; a front chamber provided at one end of the heating chamber; and a first cooling chamber cooling the treatment object in an inert gas atmosphere, a vacuum purge chamber, and a second cooling chamber cooling the treatment object in an oxidizing gas atmosphere, which are connected in this order to the other end of the heating chamber, in which the treatment object transferred from the front chamber to the heating chamber is subjected to the heating in the heating chamber, and then subjected to one cooling selected from the cooling in the inert gas atmosphere in the first cooling chamber and the cooling in the oxidizing gas atmosphere in the second cooling chamber depending on a type of the treatment object.

### FIELD OF THE INVENTION

The present invention relates to a continuous heat treatment furnace for subjecting, to a heat treatment, a treatment object which is made from a steel material such as a wire material wound in the form of a coil and a rod stock material.

### BACKGROUND OF THE INVENTION

A wire material or a rod stock material obtained by hot rolling (hereinafter referred to as rolled material) is subjected to an annealing treatment for improvement of processability in advance of a secondary processing such as wire drawing, and, in the case of performing further wire drawing for achieving a smaller diameter on a wire material that has been obtained by subjecting the rolled material to the wire drawing (hereinafter referred to as drawn material), another annealing treatment is further performed for improvement of processability.

Since the rolled material among the above-described objects that will be treated by the annealing treatment has a rolling scale that is formed on a surface thereof due to the hot rolling, a heat treatment apparatus for oxidizing a surface of an treatment object in an oxidation atmosphere after heating the treatment object in a reducing atmosphere and then rapidly cooling the treatment object in the air or the like has been proposed as a heat treatment apparatus capable of facilitating descaling of the rolling scale after the annealing (see, for example, JP-A-7-34139).

However, the apparatus disclosed in JP-A-7-34139 is used for heating the treatment object in a reducing atmosphere. Therefore, it is necessary to perform atmosphere control for continuously changing a PF value (potential factor) decided by a ratio between concentrations of CO and CO₂ depending on a furnace temperate and a type of steel so that the treatment object is not decarburized nor carburized, for example by controlling the endothermic gas. Also, the apparatus disclosed in JP-A-7-34139 requires preliminary pickling before the heat treatment in order to ensure a post pickling property in the ease of treating the rolled material.

### SUMMARY OF THE INVENTION

Therefore, the inventors of the present application have made intensive studies. As a result, they have found that it is possible to realize easy furnace atmosphere control without limitation by a furnace temperature and a steel type as well as to obtain a treated product that has a good descaling property after annealing by performing heating and cooling of an treatment object formed from a rolled material in an inert gas atmosphere. Also, the inventors have found that, even when a preliminary pickling is omitted, it is possible to obtain a treated product having a good descaling property after annealing by performing heating and cooling of a treatment object formed from a rolled material in an inert gas atmosphere. The above features are realized since the cooling in inert gas atmosphere enables to prevent transformation of wustite (FeO) into magnetite (Fe₃O₄). However, in case that the treatment object is made from the above-described drawn material, it was found that a new problem that a lubricant adhered to a surface of the drawn material is carbonized due to the heating in the inert gas atmosphere and is not removed even in the post pickling step, resulting in disturbance for the following wire drawing step.

The present invention has been accomplished in view of the above problems, and an object thereof is to provide a continuous heat treatment furnace that enables easy atmosphere control in a heating chamber, omission of preliminary pickling in the case of treating a rolled material, and is also capable of obtaining a treated product having good post pickling property from each of both treatment objects, i.e. from each of a rolled material and a drawn material.

In order to achieve the above-mentioned object, the present invention provides a continuous heat treatment furnace including: a heating chamber heating a treatment object in an inert gas atmosphere; a front chamber provided at one end of the heating chamber; and a first cooling chamber cooling the treatment object in an inert gas atmosphere, a vacuum purge chamber, and a second cooling chamber cooling the treatment object in an oxidizing gas atmosphere, which are connected in this order to the other end of the heating chamber, in which the treatment object transferred from the front chamber to the heating chamber is subjected to the heating in the heating chamber, and then subjected to one cooling selected from the cooling in the inert gas atmosphere in the first cooling chamber and the cooling in the oxidizing gas atmosphere in the second cooling chamber depending on a type of the treatment object.

According to the continuous heat treatment furnace having the above-described constitution, since the treatment object that has been transferred to the heating chamber via the front chamber is subjected to the heat treatment in the inert gas atmosphere such as N₂ in the heating chamber, the treatment object is not decarburized nor carburized to make the atmosphere control in the heating chamber far easier as compared to atmosphere control in a reducing atmosphere, which is associated with a furnace temperature and a steel type. Since the heating chamber is kept to the inert gas atmosphere, in case that the treatment object is a rolled material, a rolling scale that has been formed on a surface of the rolled material due to omission of preliminary pickling is heated without being oxidized nor deoxidized. Alternatively, in case that the treatment object is a drawn material, a lubricant that has adhered to a surface of the drawn material becomes a carbide and is heated without being oxidized nor deoxidized. After that, the treatment object is transferred to the cooling step in each case.

In case that the treatment object is a rolled material, after the heat treatment for the treatment object in the heating chamber is terminated, the treatment object transferred from the heating chamber is cooled in the first cooling chamber kept to the inert gas atmosphere such as N₂. Accordingly, the rolling scale is decreased in temperature without being oxidized nor deoxidized, the phenomenon of transformation of wustite (FeO) in the rolling scale into magnetite (Fe₃O₄) which is rigid and has poor pickling property is prevented, thereby facilitating descaling by post pickling and enabling omission of preliminary pickling. Further, by performing rapid cooling at a cooling rate of 8° C./min or more, more preferably at a cooling rate of 10° C./min or more as the cooling, many cracks reaching to a surface of a matrix are formed on the rolling scale, whereby the descaling by post pickling becomes easier. The treatment object after the cooling is passed through the second cooling chamber via the vacuum purge chamber without any cooling treatment and discharged to the outside of the furnace.

On the other hand, in case that the treatment object is a drawn material, the treatment material after the heat treatment is transferred to the second cooling chamber via the first cooling chamber and the vacuum purge chamber without being cooled in the first cooling chamber and then subjected to cooling in the second cooling chamber kept to the oxidizing gas atmosphere. Accordingly, the carbide clung onto the surface of the drawn material is oxidized and the post pickling thus becomes easy. As the cooling in this case, rapid cooling at a cooling rate of 8° C./min or more may preferably be performed in order to prevent a wustite layer on a drawn material surface from being transformed into magnetite due to the cooling. The treatment object after the cooling is discharged from the second cooling chamber to the outside of the furnace.

As described above, according to the present invention, it is possible to provide a continuous heat treatment furnace that realizes easy atmosphere control in the heating chamber and enables to omit preliminary pickling in the case of treating a rolled material as well as to obtain a treated product having good post pickling property from each of both treatment objects, i.e. from each of a rolled material and a drawn material. Also, since it is unnecessary to provide a dedicated heat treatment furnace separately for each of the rolled material and the drawn material, it is possible to reduce an equipment cost and installation space.

### BRIEF DESCRIPTION OF THE DRAWINGS

FIG. 1 is a sectional view showing a continuous heat treatment furnace as one embodiment of the present invention.

### DESCRIPTION OF REFERENCE NUMERALS AND SIGNS

1 continuous heat treatment furnace
2 front chamber
3 heating chamber
4 first cooling chamber
5 vacuum purge chamber
6 second cooling chamber
7 hearth roller
11 N₂ gas generator
12 piping
13 open/close valve
21 communicating piping
22 open/close valve
23 inert gas introduction piping
24 open/close valve
26 inert gas introduction piping
27 vacuum pump
28 exhaust piping
29 open/close valve
30 open/close valve

### BEST MODE FOR CARRYING OUT THE INVENTION

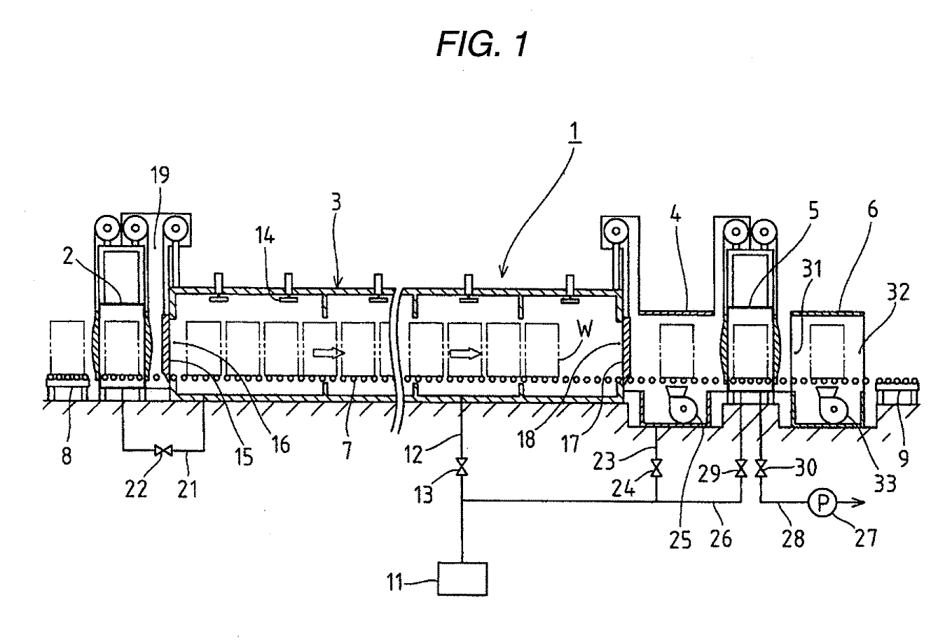

Hereinafter, one embodiment of the present invention will be described with reference to FIG. 1. FIG. 1 is a diagram showing whole of a continuous heat treatment furnace 1, in which a first cooling chamber 4, a vacuum purge chamber 5, and a second cooling chamber 6 are connected to one end of a heating chamber 3 provided with a front chamber 2 at the other end thereof. Denoted by 7 is a hearth roller provided along a whole length of the furnace for transferring a treatment object W; denoted by 8 is a charging table provided at the outside of an entrance of the front chamber 2; and denoted by 9 is a discharging table provided at the outside of an exit of the second cooling chamber 6.

The heating chamber 3 is used for heating the treatment object W in an inert gas atmosphere, and a N₂ gas is used as the inert gas in this embodiment. The N₂ gas is supplied to the heating chamber 3 via a piping 12 from a N₂ gas generator 11 (gas cylinder), and denoted by 13 is an open/close valve provided on the piping 12. A heater (not shown) of a radiant tube burner type is provided in the heating chamber 3, and denoted by 14 is a recirculating fan. Denoted by 15 is a door of an entrance 16 of the heating chamber 3, and denoted by 17 is a door of an exit 18 of the heating chamber 3, which forms a partitioning door between the heating chamber 3 and the first cooling chamber 4.

The front chamber 2 provided in front of the entrance 16 of the heating chamber 3 via a door 19 is provided with a door that can be tightly sealed and serves as a purge chamber for purging the front chamber 2 with the N₂ gas atmosphere in advance of charging the treatment object W to the heating chamber 3. In this embodiment, the front chamber 2 is provided with an open/close valve 22 on a communicating piping 21 which provides connection between the heating chamber 3 and the front chamber 2 to be used as a purge gas introduction means.

The first cooling chamber 4 provided at the rear of the exit 18 of the heating chamber 3 is used for cooling the treatment object W in an inert gas atmosphere, to which an inert gas introduction piping 23 connected to the N₂ gas generator 11 is connected. Denoted by 24 is an open/close vale provided on the introduction piping 23. A blower 25 for blowing cooling gas is provided at a bottom of a furnace shell of the first cooling chamber 4, and a cooling device formed of a heat exchanger (not shown) for cooling the atmosphere gas is provided on inside of side wall of the furnace shell.

The vacuum purge chamber 5 provided at the rear of the first cooling chamber 4 is provided with a door that can be tightly sealed and used for purging the purge chamber with the N₂ gas atmosphere when charging and discharging the treatment object W to/from the first cooling chamber 4, to which an inert gas introduction piping 26 connected to the N₂ gas generator 11 and an exhaust piping 28 reaching a vacuum pump 27 are connected. Denoted by 29 and 30 are open/close valves provided on the pipings.

The second cooling chamber 6 provided at the rear of the vacuum purge chamber 5 is used for cooling the treatment object in an oxidizing gas atmosphere, and air is used as an oxidizing gas in this embodiment. In the second cooling chamber 6, a blower 33 for blowing cooling gas, which is the similar to that of the first cooling chamber 4, is provided at a bottom of a furnace shell that is not provided with any doors at an entrance 31 and an exit 32 and opened in front/rear directions, and a cooler (not shown) which is the similar to that of the first cooling chamber 4 is provided on inside of side wall of the furnace shell.

The treatment object W which is an object of the heat treatment of the continuous heat treatment furnace 1 having the above-described constitution is obtained by winding a wire material made from a low/high carbon steel materials (including special steel), and two types of treatment object W, namely, a wire material made from a hot rolling wire material obtained by hot rolling (hereinafter referred to as a rolled material) and a wire material obtained by subjecting the hot rolling wire material to drawing or a wire material obtained by subjecting the wire material to higher-level drawing (hereinafter referred to as a drawn material), are the objects of the heat treatment.

Hereinafter, a step of annealing the treatment object W will be described. Trays on each of which the treatment object W is placed are charged one by one to the heating chamber 3 via the front chamber 2 from the charging table 8. Here, after charging the treatment object W to the front chamber 2, the gas purge in the front chamber 2 is performed by supplying the N₂ gas of the heating chamber 3 to the front chamber 2 by opening the open/close valve 22 (the air in the chamber is removed from an exhaust piping which is not shown), and the treatment object W is transferred to the heating chamber 3 after the front chamber 2 is maintained to the N₂ gas atmosphere.

In the heating chamber 3, the heat treatment is performed on the treatment object W while maintaining the chamber to the N₂ gas atmosphere (inert gas atmosphere). Here, in order that the heating chamber 3 is kept to a predetermined low dew point and low oxygen concentration atmosphere at a predetermined furnace pressure, an amount of the N₂ gas at a low dew point to be supplied into the heating chamber 3 is controlled by way of open/close control of the open/close valve 13 by a control device (not shown).

During transfer of the treatment object W in the heating chamber 3 from an inner side of the entrance 16 to an inner side of the exit 18, a heat treatment, in which the treatment object W is retained at a predetermined temperature for a predetermined time after raising the temperature to the predetermined temperature, is performed depending on a steel type of the treatment object W and a type of annealing such as low temperature annealing, soft annealing, and spheroidizing annealing. Since the heating is performed in the N₂ gas atmosphere, in case that the treatment object W is a rolled material, a rolling scale that has been formed on a surface of the rolled material due to omission of preliminary pickling is raised in temperature without being oxidized nor deoxidized. On the other hand, in case that the treatment object W is a drawn material, a lubricant that has adhered to a surface of the drawn material is raised in temperature without being oxidized nor deoxidized, to thereby become a carbide.

In case that the treatment object W is made from a rolled material, the treatment object W after the heat treatment in the heating chamber 3 is transferred to the first cooling chamber 4 kept to the N₂ gas atmosphere to be subjected to a cooling treatment in the first cooling chamber 4. Thus, the rolling scale of the treatment object W is fallen in temperature without being oxidized nor deoxidized, so that the phenomenon of transformation of wustite (FeO) in the rolling scale into magnetite (Fe₃O₄) which is rigid and has poor pickling property is prevented unlike the case of cooling the treatment object in an oxidizing gas atmosphere such as air, thereby facilitating descaling by post pickling and enabling omission of the preliminary pickling. Further, by performing rapid cooling at a cooling rate of 8° C./min or more, more preferably at a cooling rate of 10° C./min or more as the cooling treatment, many cracks reaching to a surface of a matrix are formed on the rolling scale, whereby the descaling by post pickling becomes easier. The treatment object after the cooling is passed through the second cooling chamber 6 via the vacuum purge chamber 5 without any cooling treatment and discharged to the outside of the furnace.

On the other hand, in case that the treatment object W is made from a drawn material, the treatment object W after the heat treatment is transferred to the second cooling chamber 6 via the first cooling chamber 4 and the vacuum purge chamber 5 without being cooled in the first cooling chamber 4 and then subjected to cooling in the second cooling chamber 6 kept to the air atmosphere (oxidizing gas atmosphere). Accordingly, the carbide clung onto the surface of the treatment object is oxidized and the carbide elimination by post pickling thus becomes easy. As the cooling of the treatment object W in the air atmosphere, rapid cooling at a cooling rate of 8° C./min or more may preferably be performed in order to prevent a wustite layer on a drawn material surface from being transformed into magnetite due to the cooling, and the rapid cooling ensures prevention of formation of a rigid magnetite layer as well as prevention of occurrence of problems in subsequent process steps. The treatment object after the cooling is discharged from the exit 32 of the second cooling chamber 6 to the outside of the furnace.

In each of case that the treatment object W is the rolled material and the case that the treatment object W is the drawn material, the treatment object W is cooled to a predetermined temperature (for example 400° C. which is a temperature equal to or less than an transformation temperature of wustite, although the temperate is varied depending on the steel type), and the treatment object is then discharged to the discharging table 9 as a treated product. Subsequently, after exhausting the vacuum purge chamber 5 by the vacuum pump 27, the open/close valve 29 is opened to keep the vacuum purge chamber 5 to the N₂ gas atmosphere, and a subsequent treatment object W after the heat treatment is transferred from the heating chamber 3 to the first cooling chamber 4 or the second cooling chamber 6 depending on the type of the treatment object W (rolled material or drawn material) in the same manner as described above, followed by performing a similar cooling treatment as described above.

As described above, in the continuous heat treatment furnace 1, since the heating step for the treatment object W is performed in the heating chamber 3 kept to the inert gas atmosphere, the treatment object is not decarburized nor carburized by the atmosphere gas, and the atmosphere control in the heating chamber is far easier as compared to the atmosphere control associated with a furnace temperature and a steel type for heating in a reducing atmosphere.

The cooling step for the treatment object W after the heat treatment is performed by selecting the atmosphere for the cooling depending on the type of the treatment object (rolled material or drawn material). The inert gas atmosphere of the first cooling chamber 4 is selected in case that the treatment object is s rolled material, and the oxidizing gas atmosphere of the second cooling chamber 6 is selected in case that the treatment object W is a drawn material. As described above, due to the cooling treatment by selecting the first or second cooling chamber, the rolling scale formed on the surface due to the omission of the preliminary pickling is easily removed by the post pickling in the case of the rolled material, and the carbide on the surface is oxidized to be easily removed by the post pickling in the case of the drawn material, thereby making it possible to obtain the treated objects having good post pickling property in both cases. In case that the treatment object W is a rolled material, omission of the preliminary pickling is further realized. Since the heat treatment and the cooling treatments can be performed in one continuous heat treatment furnace 1, and since it is unnecessary to provide heat treatment furnaces separately for the rolled material and the drawn material, it is possible to reduce an equipment cost and installation space for the heat treatment furnace.

The present invention is not limited to the above-described embodiment. For example, although an N₂ gas is used as the inert gas in the above-described embodiment, other inert gases such as an Ar gas may be used. Also, a treatment object having a feature that a plurality of bar materials are laminated on a rack or the like may be the object of the heat treatment without limitation to the above-described wire material in the form of a coil. Also, the front chamber 2 may be a vacuum purge chamber having a structure similar to that of the vacuum purge chamber 5, and the second cooling chamber 6 may be a cooling chamber provided with a door on each of the entrance 31 and the exit 32.

The present application is based on Japanese Patent Application No. 2008-239515 filed on Sep. 18, 2008, the contents thereof being incorporated herein by reference.

What is claimed is:

1. A continuous heat treatment furnace comprising:
a heating chamber heating a treatment object in an inert gas atmosphere;
a front chamber provided at one end of the heating chamber; and
a first cooling chamber cooling the treatment object in an inert gas atmosphere, a vacuum purge chamber, and a second cooling chamber cooling the treatment object in an oxidizing gas atmosphere, which are connected in this order to the other end of the heating chamber,
wherein the treatment object transferred from the front chamber to the heating chamber is subjected to said heating in the heating chamber, and then subjected to one cooling selected from the cooling in the inert gas atmosphere in the first cooling chamber and the cooling in the oxidizing gas atmosphere in the second cooling chamber depending on a type of the treatment object.
